(19) United States
(12) Patent Application Publication
(10) Pub. No.: US 2018/0107392 A1
(43) Pub. Date: Apr. 19, 2018

(54) MEMORY MANAGEMENT SYSTEM AND METHOD THEREOF

(71) Applicant: ALIANE TECHNOLOGIES CO.,, TAIPEI CITY (TW)

(72) Inventors: CHIA-CHEN HU, TAIPEI CITY (TW); HUAI-EN CHEN, TAIPEI CITY (TW)

(21) Appl. No.: 15/297,745

(22) Filed: Oct. 19, 2016

(51) Int. Cl. G06F 3/06

(52) U.S. Cl. CPC G06F 3/0604; G06F 3/067; G06F 3/0631

(57) ABSTRACT

Disclosed are a memory management system and a method thereof. The memory management system is configured on a mother board of a server to help a central processing unit of the server to do memory management for a device system. A memory block is connected to the central processing unit of the server and a plurality of host devices are configured in the device system. The system is configured to determine an amount of the host devices configured in the device system; provide a device code to each host device; determine the memory capacity of the memory block; and allocate memory to each host device and accordingly build an allocation table. When the host device requests the central processing unit for accessing data, the central processing unit responds to the host device according to the allocation table, such that the host device uses the memory block to access data.

### BACKGROUND OF THE INVENTION

### 1. Field of the Invention

The instant disclosure relates to a memory management system and a method thereof; in particular, to a memory management system and a method thereof that help the central processing unit of a server to do memory management for a device system.

### 2. Description of Related Art

Recently, the cost of common computer hardware has been quite reasonable, and large server systems have been more and more the norm, and thus virtual devices have become valued more by people. The virtual device can be considered an interface between the software and the computer system to provide resources of the computer system to the software. Usually, the software is an operating system. The operating system can access the resources of the computer system through the virtual device. A plurality of virtual devices can be configured in one computer system, and different virtual devices can run different operating systems. For example, the Widows operating system and the Linux operating system can be respectively run by different virtual devices in the same computer system. In brief, the virtual device must be a host device. According to the requirements of different users, different host devices may be assigned different tasks. Thus, how to effectively allocate resources (especially the memory) of a computer system to different host devices according to requirements of different users is still worth discussing.

### SUMMARY OF THE INVENTION

The instant disclosure provides a memory management method. This memory management method is used to help a central processing unit of a server to do memory management for a device system. A memory block is connected to the central processing unit of the server, and there is a plurality of host devices configured in the device system. This memory management method comprises: determining an amount of the host devices configured in the device system; providing a device code to each host device; determining the memory capacity of the memory block; and allocating memory to each host device and accordingly building an allocation table. When the host device makes a request to the central processing unit for accessing data, the central processing unit responds to the host device according to the allocation table, such that the host device uses the memory block to access data.

The instant disclosure further provides a memory management system. This memory management system is configured on a mother board of a server to help a central processing unit of the server to do memory management. A memory block is connected to the central processing unit of the server, and there is a plurality of host devices configured in the device system. The memory management system comprises a memory allocation module and an interconnection module. The memory allocation module is configured for: determining an amount of the host devices configured in the device system; providing a device code to each host device; determining the memory capacity of the memory block; and allocating memory to each host device and accordingly building an allocation table. The interconnection module is connected between the memory allocation module and the host devices of the device system. When the host device sends a request signal for accessing data, the interconnection module converts the request signal and transmits the converted request signal to the central processing unit. After that, the central processing unit responds to the request signal of the host device according to the allocation table such that the host device uses the memory block to access data.

To sum up, the major achievement of the memory management system and the memory management method provided by the instant disclosure is to help the central processing unit to allocate memory to each host device to use. In addition, the memory management system provided by the instant disclosure is directly configured on the mother board of a server. Thus, provided with the requirements and the needs of a general client or an enterprise client, a customized memory management system can be built. After that, this customized memory management system can be directly configured on the mother board of a server of the general client or the enterprise client, and it can start to help the central processing unit to allocate memory to each host device to use.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a flow chart of a memory management method of one embodiment of the instant disclosure.

FIG. 2 shows a schematic diagram of an allocation table of one embodiment of the instant disclosure.

FIG. 3 shows a block diagram of a memory management system of one embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

### One Embodiment of the Memory Management Method

The memory management method provided by this embodiment is mainly to help a central processing unit of a server of a general client or an enterprise client to do memory management for a device system they use. The detailed descriptions are as follows.

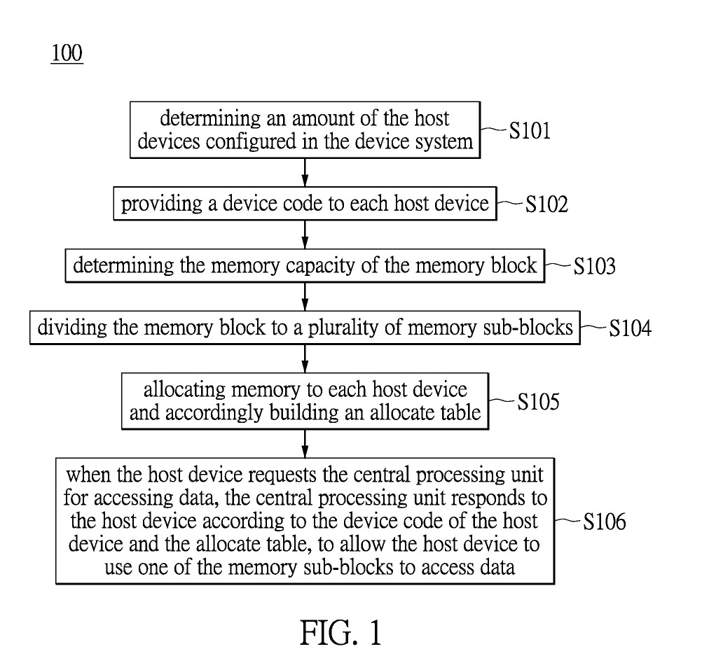

Referring to FIG. 1, FIG. 1 shows a flow chart of a memory management method of one embodiment of the instant disclosure. As shown in FIG. 1, the memory management method 100 provided by this embodiment is implemented by the following steps: step S101: determining an amount of the host devices configured in the device system; step S102: providing a device code to each host device; step S103: determining the memory capacity of the memory block; step S104: dividing the memory block to a plurality of memory sub-blocks; step S105: allocating memory to each host device and accordingly building an allocation table; and step S106: when the host device requests the central processing unit for accessing data, the central processing unit responds to the host device according to the device code of the host device and the allocation table, to allow the host device to use one of the memory sub-blocks to access data.

Specifically speaking, in step S101, the amount of the host devices configured in a device system is determined based on different requirements of a general client or an enterprise client. The device system herein refers to a plurality of host devices configured on the server of a general client or an enterprise client, wherein each host device in the device system can be provided to one user for use. When a host device is used by a user, the physical resources of the server may be requested for accessing data. In this embodiment, the physical resources of the server refer to the memory.

After that, in step S102, a device code is provided to each host device in the device system. If, for example, the amount of the host devices configured in the device system is determined to be 8, in step S102, these eight host devices in the host system are respectively given a device code, for example, from 0 to 7, but it is not limited herein.

In step S103, the memory capacity of the memory block is determined. The memory block herein refers to the above described physical resources of the server. In this embodiment, the memory block is the Double Data Rate Synchronous Dynamic Random Access Memory (DDR SDRAM). For easy instruction, in this step, the memory capacity of the memory block is determined as 512 GB. In addition, in step S104, the memory block is further divided to a plurality of memory sub-blocks. In other words, in this step, this 512 GB memory block is divided to a plurality of memory sub-blocks. The memory capacity of these memory sub-blocks can be 1 GB, 2 GB, 4 GB, 8 GB, 16 GB and the like. The memory capacity of the memory sub-blocks may be all different, or some of the memory sub-blocks may have the same memory capacity.

The reason why the memory block is divided to a plurality of memory sub-blocks in step S104 is that, the general client or the enterprise client may assign different tasks to different host devices (that is, different host devices may be used to do different work). After the memory block is divided to the 1 GB, 2 GB, 4 GB, 8 GB, 16 GB memory sub-blocks or the like, in step S105, these memory sub-blocks are allocated to each host device. It should be noted that, the memory capacity of the one memory sub-block the host device is allowed to use equals to the memory capacity of the memory allocated to the host device according to the allocation table. Take the above case for example, the memory capacity of the memory sub-block that is allocated to each host device needs to be 1 GB, 2 GB, 4 GB, 8 GB, 16 GB or the like.

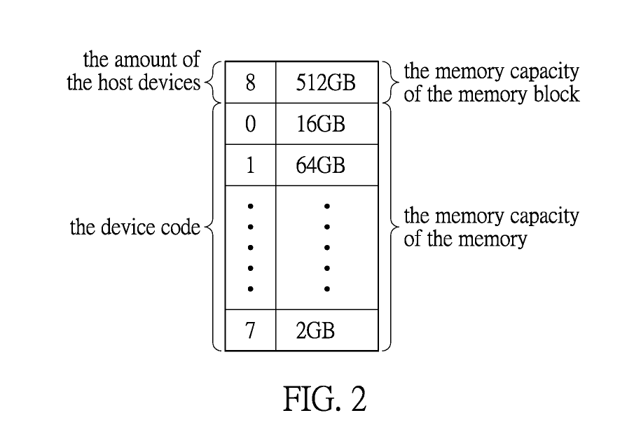

In step S105, an allocation table is built. This allocation table records a relationship between the device code of each host device and the memory allocated to each host device. Referring to FIG. 2, FIG. 2 shows a schematic diagram of an allocation table of one embodiment of the instant disclosure. According to the allocation table shown in FIG. 2, the memory capacity of the memory sub-block allocated to the host device having a device code “0” is 16 GB, the memory capacity of the memory sub-block allocated to the host device having a device code “1” is 64 GB, and the memory capacity of the memory sub-block allocated to the host device having a device code “7” is 2 GB. However, the allocation table shown in FIG. 2 is only for illustrating how those memory sub-blocks are allocated to the host devices but not for restricting the instant disclosure. Additionally, in this embodiment, the allocation table records the determined memory capacity of the memory block (that is, the allocation table in FIG. 2 records that the determined memory capacity of the memory block is 512 GB). The allocation table also records the determined amount of the host devices of the device system (that is, the allocation table in FIG. 2 records that the determined amount of the host devices of the device system is 8).

Finally, in step S106, when a user operates one host device of the device system, this host device requests the central processing unit for accessing data. The central processing unit first recognizes the device code of the host device, and then responds to the host device according to the recognized device code and the allocation table. Herein, the response from the central processing unit is to allow the host device to use one of the memory sub-blocks for accessing data, wherein the memory capacity of the memory sub-block the host device is allowed to use is determined according to the allocation table. As described, the memory capacity of the memory sub-blocks may be all different, or some of the memory sub-blocks have the same memory capacity. Thus, in the allocation table, different device codes may be respectively corresponded to memory sub-blocks having the same memory capacity.

It is worth mentioning that, in this embodiment, the device system can be a physical device system or a virtual device system. In other words, the memory management method provided by this embodiment can be adapted to a virtual device system comprising a plurality of virtual devices. Herein, the virtual device refers to the so-called Virtual Machine (VM).

### One Embodiment of the Memory Management System

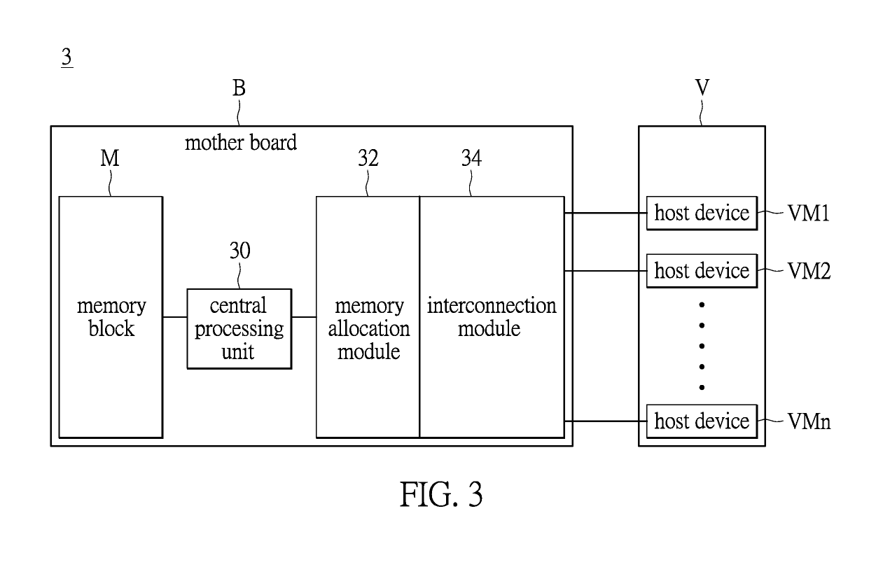

The memory management system provided by this embodiment is used to implement the memory management method provided by the above embodiment. Referring to FIG. 3, FIG. 3 shows a block diagram of a memory management system of one embodiment of the instant disclosure.

The memory management system 3 in this embodiment is mainly used to help the central processing unit 30 of a server to do memory management for a device system V. As shown in FIG. 3, a memory block M is connected to the central processing unit 30 on the mother board B. There is a plurality of host devices VM1, VM2, . . . VMn configured in the device system V, wherein “n” is a positive integer. In this embodiment, the memory block is also the Double Data Rate Synchronous Dynamic Random Access Memory (DDR SDRAM), and the amount of the host devices configured in the device system V, which is “n”, is determined based on the requirement and needs of different clients.

The memory management system 3 provided by this embodiment comprises a memory allocation module 32 and an interconnection module 34. The memory allocation module 32 and the interconnection module 34 are directly configured on the mother board B of a server. The interconnection module 34 can be the Peripheral Component Interconnect Express (PCI-E) bus, the Signal Root I/O Virtualization (SRIOV) bus or the Multi Root I/O Virtualization (MRIOV) bus. Preferably, the interconnection module 34 is implemented by the Signal Root I/O Virtualization (SRIOV) bus. In addition, the memory allocation module 32 can be implemented by the Field-Programmable Gate Array (FPGA) chip. The FPGA chip is reprogrammable, so that the instant disclosure can provide a customized memory management system for a client.

By programming the memory allocation module 32 (e.g., a FPGA chip), the amount of the host devices VM1, VM2, . . . VMn in the device system V can be determined. After that, according to the requirement and needs of a general client or an enterprise client, the memory allocation module 32 determines the memory capacity of the memory block, and divides the memory block to a plurality of memory sub-blocks (not shown). Finally, again by programming the memory allocation module 32, the memory capacity of the memory sub-block that each host device VM1, VM2, . . . VMn is allowed to use can be determined, and then an allocation table can be accordingly built. This allocation table records the relationship between the device code of each host device and the memory allocated to each host device, but the details relevant to the allocation table are omitted herein because they have been described in the last embodiment and FIG. 2.

When a user operates one host device VM1, VM2, . . . VMn configured in the device system V, this host device requests the central processing unit for accessing data. After recognizing the device code of the host device, the central processing unit responds to the host device according to the allocation table and the recognized device code. Herein, the response from the central processing unit is to allow the host devices to use one of the memory sub-blocks (not shown) for accessing data, and particularly the memory capacity of the memory sub-block the host device is allowed to use is determined according to the allocation table.

As described, the memory capacity of the memory sub-blocks may be all different, or some of the memory sub-blocks may have the same memory capacity. Thus, according to the allocation table, different device codes may be corresponded to the memory sub-blocks that have the same memory capacity. In any case, the memory that is allocated to each host device VM1, VM2, . . . VMn must be equal to the memory capacity of one of the memory sub-blocks. Therefore, how to divide the memory block to a plurality of memory sub-blocks is determined by the memory that each host device VM1, VM2, . . . VMn needs to do its work or can be allowed to use.

According to the above description, the device system in this embodiment can be a physical device system or a virtual device system. In other words, the memory management system provided by this embodiment can do the memory management for a virtual device system having a plurality of virtual devices. Herein, the virtual device refers to the so-called Virtual Machine (VM). In recent years, to simplify the management of a server and a corresponding device system, more and more enterprise clients tend to use a virtual device system. Virtual machines in the virtual device system are given different tasks according to the requirement and needs of different enterprise clients. The instant disclosure can provide a customized memory management system and a corresponding memory management method, such that the memory resource can be simply and efficiently allocated to each virtual machine in the virtual device system used by every client.

To sum up, the memory management method and the memory management system provided by the instant disclosure can help a central processing unit of a server to do memory management for a device system linked to the server. The memory management method and the memory management system provided by the instant disclosure can be customized by the requirements and needs of clients. In addition, the memory management system provided by the instant disclosure can be directly configured on the mother board of a server. Therefore, as long as a customized memory management system is directly configured on the mother board of a client server, the client can have its own memory management system to do memory management for host devices that are responsible for different work.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A memory management method, used to help a central processing unit of a server to do memory management for a device system, wherein a memory block is connected to the central processing unit of the server and there is a plurality of host devices configured in the device system, the memory management method comprising:
determining an amount of the host devices configured in the device system;
providing a device code to each host device;
determining the memory capacity of the memory block; and
allocating memory to each host device and accordingly building an allocation table;
wherein when the host device requests the central processing unit for accessing data, the central processing unit responds to the host device according to the allocation table, such that the host device uses the memory block to access data.

2. The memory management method according to claim 1, wherein the allocation table records a relationship between the device code of each host device and the memory allocated to each host device.

3. The memory management method according to claim 1, further comprising:
dividing the memory block to a plurality of memory sub-blocks;
wherein when the host device requests the central processing unit for accessing data, the central processing unit responds to the host device according to the device code of the host device and the allocation table, to allow the host device to use one of the memory sub-blocks to access data, and the memory capacity of the memory sub-block the host device is allowed to use equals to the memory capacity of the memory allocated to the host device according to the allocation table.

4. The memory management method according to claim 1, wherein the allocation table further records the determined memory capacity of the memory block and the determined amount of the host devices configured in the device system.

5. The memory management method according to claim 1, wherein the device system is a virtual device system and there is a plurality of virtual host devices configured in the virtual device system.

6. A memory management system, configured on a mother board of a server to help a central processing unit of the server to do memory management, wherein a memory block is connected to the central processing unit of the server and there is a plurality of host devices configured in the device system, the memory management system comprising:
a memory allocation module, configured to:
determining an amount of the host devices configured in the device system;
providing a device code to each host device;
determining the memory capacity of the memory block; and
allocating memory to each host device and accordingly building an allocation table; and
an interconnection module, connected between the memory allocation module and the host devices of the device system;
wherein when the host device sends a request signal for accessing data, the interconnection module converts the request signal and transmits the converted request signal to the central processing unit, and the central processing unit responds to the request signal of the host device according to the allocation table such that the host device uses the memory block to access data.

7. The memory management system according to claim 6, wherein the allocation table records a relationship between the device code of each host device and the memory allocated to each host device.

8. The memory management system according to claim 6, wherein the memory allocation module is further configured to:
dividing the memory block to a plurality of memory sub-blocks;
wherein when the host device sends the request signal for accessing data, the interconnection module converts the request signal and transmits the converted request signal to the central processing unit, the central processing unit responds to the host device according to the device code of the host device and the allocation table, to allow the host device to use one of the memory sub-blocks to access data, and the memory capacity of the memory sub-block the host device is allowed to use equals to the memory capacity of the memory allocated to the host device according to the allocation table.

9. The memory management system according to claim 6, wherein the allocation table further records the determined memory capacity of the memory block and the determined amount of the host devices configured in the device system.

10. The memory management system according to claim 6, wherein the device system is a virtual device system and there is a plurality of virtual host devices configured in the virtual device system.
